(19) United States
(12) Patent Application Publication
(10) Pub. No.: US 2017/0003179 A1
(43) Pub. Date: Jan. 5, 2017

(54) FAULT DIAGNOSIS SYSTEM AND METHOD OF EXHAUST GAS TEMPERATURE SENSOR OF HYBRID VEHICLE

(71) Applicants: HYUNDAI MOTOR COMPANY, Seoul (KR); KIA MOTORS CORPORATION, Seoul (KR)

(72) Inventor: Jeong Sik JIN, Ansan-si (KR)

(73) Assignees: HYUNDAI MOTOR COMPANY, Seoul (KR); KIA MOTORS CORPORATION, Seoul (KR)

(21) Appl. No.: 14/944,998

(22) Filed: Nov. 18, 2015

(30) Foreign Application Priority Data
Jun. 30, 2015 (KR) 10-2015-0093607

(51) Int. Cl. G01K 19/00; F01N 13/00; F01N 11/00

(52) U.S. Cl. CPC G01K 19/00; F01N 11/002; F01N 13/008; F01N 2560/06

(57) ABSTRACT

An exhaust temperature sensor fault diagnosis method of a hybrid vehicle includes: determining whether a starting of the vehicle is turned on depending on an operation of a starter switch; determining whether a fault diagnosis condition of the exhaust temperature sensor is satisfied; diagnosing the fault of the exhaust temperature sensor if the fault diagnosis condition of the exhaust temperature sensor is satisfied; determining whether the engine is driving during the fault of the exhaust temperature sensor is diagnosed; and finishing the fault diagnosis of the exhaust temperature sensor if the engine is not driving.

### CROSS-REFERENCE TO RELATED APPLICATION

This application claims the benefit of the Korean Patent Application No. 10-2015-0093607, filed on Jun. 30, 2015, which is incorporated herein by reference in its entirety.

### FIELD

The present disclosure relates to an exhaust temperature sensor fault diagnosis system of a hybrid vehicle and a method thereof.

### BACKGROUND

The statements in this section merely provide background information related to the present disclosure and may not constitute prior art.

A hybrid electric vehicle may form various structures using two or more power sources including an engine and a motor. The hybrid electric vehicle uses a power train in a manner of a transmission mounted electronic device (TMED) in which a motor, and a transmission and drive shaft are connected in series to each other.

In addition, a clutch is disposed between an engine and a motor. According to whether the clutch is engaged, the hybrid electric vehicle is driven in an electric vehicle (EV) mode or in a hybrid electric vehicle (HEV) mode.

The EV mode is a mode in which a vehicle is driven by only driving torque of a motor. The HEV mode is a mode in which the vehicle is driven by driving torque of the motor and the engine. Accordingly, when the hybrid electric vehicle is driven, the engine may maintain a driving state or a stop state.

A SCR catalyst is provided in an exhaust pipe in which an exhaust gas exhausted from the engine flows, for controlling the SCR catalyst, an exhaust temperature sensor sending a temperature of the exhaust gas is provided in the SCR catalyst.

In the state that the engine is stropped, since the temperature of the exhaust gas is low, the SCR catalyst is inactivated such that it is not necessary to monitor the fault diagnosis of the exhaust temperature sensor.

However, if the engine is driven, since the temperature of the exhaust gas is increased, the SCR catalyst is activated. As described above, the SCR catalyst is activated such that it is necessary to monitor the fault diagnosis of the exhaust temperature sensor during the SCR catalyst control is performed (a Raw NOx model is calculated).

However, we have discovered that the hybrid electric vehicle generally monitors the fault diagnosis of the exhaust temperature sensor regardless of the driving of the engine. That is, the hybrid electric vehicle according to the conventional art constantly monitors the fault diagnosis of the exhaust temperature sensor until the starting switch is turned off from the turned on. As described above, the unnecessary fault diagnosis for the exhaust temperature sensor may cause an erroneous sensing for the exhaust temperature sensor.

### SUMMARY

The present disclosure provides an exhaust temperature sensor fault diagnosis system of a hybrid vehicle monitoring the fault diagnosis of the exhaust temperature sensor in a condition that the SCR catalyst is activated by the driving of the engine (a fault diagnosis condition of the exhaust temperature sensor).

Also, the present disclosure provides an exhaust temperature sensor fault diagnosis method of the hybrid vehicle monitoring the fault diagnosis of the exhaust temperature sensor in the condition that the SCR catalyst is activated by the driving of the engine using the system.

An exhaust temperature sensor fault diagnosis method of a hybrid vehicle according to an embodiment of the present disclosure includes determining whether a starting of the vehicle is turned on depending on an operation of a starter switch; determining whether a fault diagnosis condition of the exhaust temperature sensor is satisfied; diagnosing the fault of the exhaust temperature sensor if the fault diagnosis condition of the exhaust temperature sensor is satisfied; determining whether the engine is driving during the fault of the exhaust temperature sensor is diagnosed; and finishing the fault diagnosis of the exhaust temperature sensor if the engine is not driving.

The fault diagnosis condition of the exhaust temperature sensor may be satisfied if the driving time of the engine exceeds a predetermined driving time, the exhaust temperature exceeds a predetermined temperature, and the exhaust temperature lasts during a predetermined time that the exhaust temperature exceeds the predetermined temperature.

If the output voltage of the exhaust temperature sensor exceeds an uppermost predetermined value, it may be diagnosed that the fault is generated in a power line of the exhaust temperature sensor, and if the output voltage of the exhaust temperature sensor is smaller than a lowermost predetermined value, it may be diagnosed that the fault is generated in a ground line of the exhaust temperature sensor.

The fault diagnosis condition of the exhaust temperature sensor may be satisfied if the driving time of the engine exceeds the predetermined driving time and the exhaust temperature is smaller than the threshold temperature.

If the driving time of the engine exceeds the predetermined driving time and the exhaust temperature is smaller than the threshold temperature, it may be diagnosed that the fault is generated in the exhaust temperature sensor itself.

If the accumulation fuel injection amount reaches the predetermined value, it may be determined that the driving time of the engine exceeds the predetermined driving time.

An exhaust temperature sensor fault diagnosis system of a hybrid vehicle according to another embodiment of the present disclosure includes an exhaust pipe in which an exhaust gas exhausted from an engine flows; a SCR catalyst installed at the exhaust pipe and reducing a nitrogen oxide included in the exhaust gas; a exhaust temperature sensor installed at a previous stage of the SCR catalyst and measuring an exhaust temperature; and a controller determining the fault of the exhaust temperature sensor of a fault diagnosis condition of the exhaust temperature sensor is satisfied.

The controller may determine whether the fault diagnosis condition of the exhaust temperature sensor is satisfied if the driving time of the engine exceeds a predetermined driving time, the exhaust temperature exceeds a predetermined temperature, and the exhaust temperature lasts during a predetermined time that the exhaust temperature exceeds the predetermined temperature.

The controller may diagnose that the fault is generated in a power line of the exhaust temperature sensor if the output voltage of the exhaust temperature sensor exceeds an uppermost predetermined value, and diagnoses that the fault is generated in a ground line of the exhaust temperature sensor if the output voltage of the exhaust temperature sensor is smaller than a lowermost predetermined value.

The controller may determine that the fault diagnosis condition of the exhaust temperature sensor is satisfied if the driving time of the engine exceeds the predetermined driving time and the exhaust temperature is smaller than the threshold temperature.

The controller may diagnose that the fault is generated in the exhaust temperature sensor itself if the driving time of the engine exceeds the predetermined driving time and the exhaust temperature is smaller than the threshold temperature.

In an embodiment of the present disclosure, by providing the exhaust temperature sensor at the previous stage of the SCR catalyst to sense the temperature of the exhaust gas depending on the engine driving, the fault diagnosis of the exhaust temperature sensor may be monitored in the condition that the SCR catalyst is activated by the driving of the engine. That is, since the fault of the exhaust temperature sensor is not diagnosed in the condition that the SCR catalyst is not activated, the erroneous sensing for the exhaust temperature sensor may be reduced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of a hybrid vehicle according to an exemplary embodiment of the present disclosure;

FIG. 2 is a schematic diagram of an exhaust pipe in a hybrid vehicle according to an exemplary embodiment of the present disclosure;

FIG. 3 is a block diagram of an exhaust temperature sensor fault diagnosis system of a hybrid vehicle according to an exemplary embodiment of the present disclosure; and

FIG. 4 is a flowchart of an exhaust temperature sensor fault diagnosis method of a hybrid vehicle according to an exemplary embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described embodiments may be modified in various different ways, all without departing from the spirit or scope of the present disclosure.

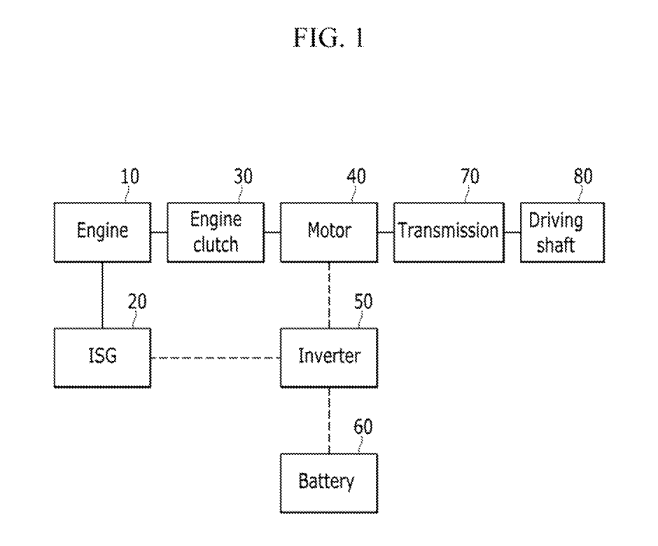

Referring to FIG. 1, the hybrid vehicle according to an exemplary embodiment includes an engine 10, power electronic components 40, 50, and 60, an integrated starter-generator (ISG) 20, an engine clutch 30, a transmission 70, and a drive shaft 80.

The exhaust temperature sensor fault diagnosis system of the hybrid vehicle according to an exemplary embodiment of the present disclosure is described as an example of a plug-in hybrid vehicle. However, the scope of the present disclosure is not limited thereto, and it may be applied to various types hybrid vehicle.

The engine 10 to generate the driving torque by a combust of the fuel may include a gasoline engine, a diesel engine, a liquefied petroleum gas (LPG) engine, a methanol engine, or a hydrogen engine.

The power electronic components 40, 50, and 60 to generate the driving torque by the power include a motor 40, an inverter 50, and a battery 60.

The motor 40 receives the power from the battery 60 to generate the driving torque. The motor 40 is selectively connected to the engine 10 through the engine clutch 30, thereby receiving the driving torque generated from the engine 10. Also, the motor 40 is connected to the transmission 70 to transmit the driving torque of the engine 10 and/or the driving torque of the motor 40 to the transmission 70.

The inverter 50 converts a DC power of the battery 60 into an AC power to apply the AC power to the motor 40. Also, the inverter 50 converts the AC power generated by the rotation of the motors 40 or the ISG 20 into the DC power to be applied to the battery 60. Accordingly, the battery 60 is charged.

The battery 60 is charged by the DC power and supplies the DC power to the inverter 50 or is supplied with the DC power from the inverter 50.

The ISG 20 is connected to the engine 10 to start the hybrid vehicle and to drive the engine 10 in low engine speed.

The engine clutch 30 is disposed between the engine 10 and the motor 40 to selectively connect the engine 10 to the motor 40. That is, if the engine clutch 30 is operated, the engine 10 is connected to the motor 40 such that the driving torque of the engine 10 is transmitted to the motor 40. Alternatively, if the engine clutch 30 is not operated, the engine 10 is not connected to the motor 40.

The transmission 70 is connected to the motor 40, thereby receiving the driving torque of the engine 10 and/or the driving torque of the motor 40. The transmission 70 changes the magnitude of the driving torque transmitted from the engine 10 and/or the motor 40 (by changing the rotation speed depending on a synchronized gear ratio).

The drive shaft 80 transmits the driving torque transmitted from the transmission 70 to a wheel (not shown), thereby realizing the driving of the hybrid vehicle. Although not shown, a differential is provided between the transmission 70 and the drive shaft 80.

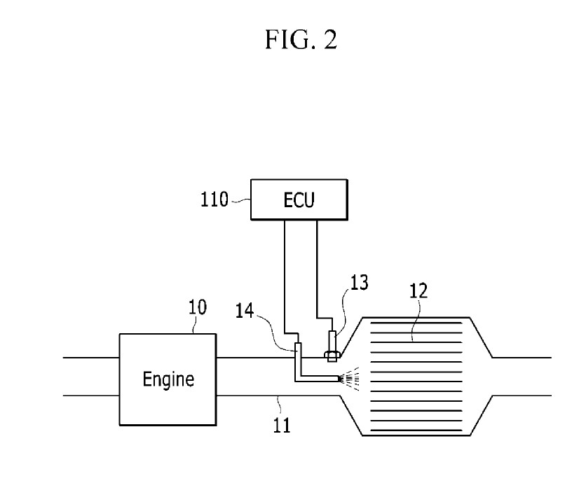

FIG. 2 is a schematic diagram of an exhaust pipe in a hybrid vehicle according to an exemplary embodiment of the present disclosure. Referring to FIG. 2, the exhaust pipe 11 is connected to an exhaust manifold (not shown) of the engine 10, thereby exhausting the exhaust gas outside the vehicle. The exhaust pipe 11 is provided with a SCR catalyst 12, an exhaust temperature sensor 13, and an injection module 14.

The SCR catalyst 12 is mounted to the exhaust pipe 11 to reduce a nitrogen oxide included in the exhaust gas by using a reducing agent.

The exhaust temperature sensor 13 is mounted to a previous exhaust pipe 11 of the SCR catalyst 12, thereby measuring the exhaust gas temperature in the previous stage of the SCR catalyst 12 for the control of the SCR catalyst 12. Although not shown, the exhaust temperature sensor is mounted inside the SCR catalyst, thereby measuring the temperature of the exhaust gas inside the SCR catalyst.

For convenience, the temperature of the SCR catalyst 12 used in the present exemplary embodiment represents the temperature of the exhaust gas in the previous state of the SCR catalyst 12 or the temperature of the exhaust gas inside the SCR catalyst 12.

The injection module 14 may directly injects an urea or may inject an ammonia to supply a reducing agent to the SCR catalyst 12. Also, the injection module 14 may inject other reducing agent except for ammonia along ammonia or itself.

Although not shown, the injection module 14 is connected with an urea tank and an urea pump. That is, the urea pumped from the urea tank by the pumping of the urea pump is injected inside the exhaust pipe 11 through the injection module 14 and is mixed with the exhaust gas to be inflow to the SCR catalyst 12.

The urea injected to the exhaust gas is dissolved into ammonia by a heat of the exhaust gas, and the dissolved ammonia is acted as the reducing agent to reduce the nitrogen oxide. In the present specification and claim range, to inject the reducing agent includes to inject the material to be the reducing agent by the injection module 14.

The hybrid vehicle according to an exemplary embodiment of the present disclosure will be described below in terms of an example of a structure using a manner of a transmission mounted electric device (TMED). However, the scope of the present disclosure may not be limited thereto and may also be applied to other types of hybrid electric vehicles.

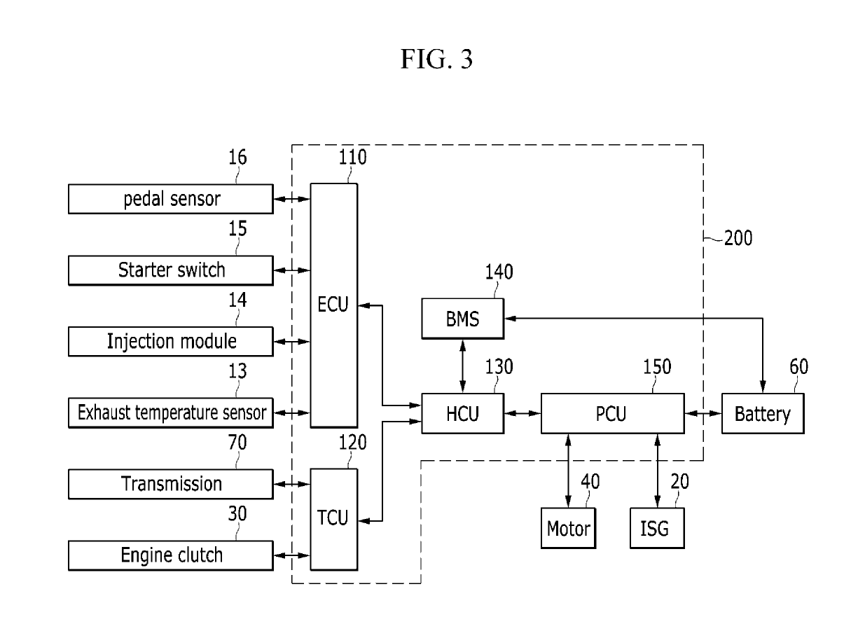

FIG. 3 is a block diagram of an exhaust temperature sensor fault diagnosis system of a hybrid vehicle according to an exemplary embodiment of the present disclosure. Referring to FIG. 3, the exhaust temperature sensor fault diagnosis system of the hybrid vehicle includes an ECU (Engine Control Unit) 110, a TCU (Transmission Control Unit) 120, a HCU (Hybrid Control Unit) 130, a BMS (Battery Management System) 140, and a PCU (Power Control Unit) 150.

The ECU 110 controls an overall operation of the engine 10 in conjunction with the HCU 130 connected through the network. The ECU 110 is electrically connected with the exhaust temperature sensor 13 to control the SCR catalyst 12, the injection module 14, the starting switch 15, the accelerator pedal sensor 16. The accelerator pedal sensor 16 detects manipulation of an accelerator pedal. An accelerator pedal change amount detected by the accelerator pedal sensor 16 is provided to the ECU 110.

The TCU 120 controls an actuator provided in the transmission 70 depending on the control of the HCU 130 connected by the network to control a shift into a target shift stage and controls a pressure of a fluid supplied to the engine clutch 30 to perform an engagement and release of the engine clutch 30, thereby controlling a delivery of a driving force of the engine 10.

The HCU (hybrid control unit) 130 is an uppermost controller and integrally controls lower controllers connected to the network to control an overall operation of the hybrid vehicle.

For example, the HCU 130 determines a driver's acceleration will from the accelerator pedal change amount detected by the accelerator pedal sensor 90 and a driving mode of the hybrid vehicle is converted into a hybrid electric vehicle (HEV) mode from an electric vehicle (EV) mode according to the driver's acceleration will.

The BMS 140 detects an information such as a voltage, a current, a temperature etc., of the battery 60 to manage the charging state of the battery 60 and controls a charging current amount or a discharging current amount of the battery 60 not to be over-discharged to a limitation voltage or less or not to be over-charged to a limitation voltage or more.

The PCU (power control unit) 105 includes an inverter 50 and a protection circuit, which include a motor control unit (MCU) and a plurality of power switching devices, and converts a direct current (DC) voltage applied from the battery 60 into a three-phase alternating current (AC) voltage to control driving of the motor 40 depending on a control signal applied from the HCU 130.

Also, the PCU 150 charges the battery 60 by using the power generated in the motor 40. In general, the ECU 110, the TCU 120, the HCU 130, the BMS 140, and the PCU 150 may be allotted to each control module, however they will be described to be integrated into one controller in the present specification. That is, the controller of the present disclosure includes the ECU 110, the TCU 120, the HCU 130, the BMS 140, and the PCU 150.

The controller may be realized by at least one processor operated by a predetermined program, and the predetermined program performs each step of the control method of the hybrid vehicle according to an exemplary embodiment of the present disclosure.

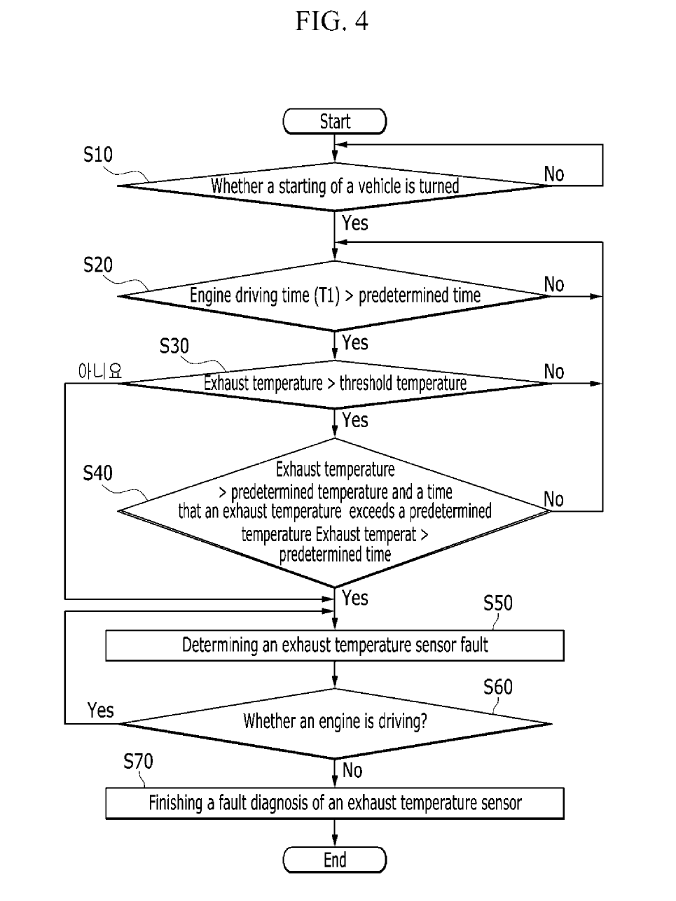

FIG. 4 is a flowchart of an exhaust temperature sensor fault diagnosis method of a hybrid vehicle according to an exemplary embodiment of the present disclosure.

Referring to FIG. 4, the controller determines whether the starting of the vehicle is turned on depending on the signal generated by the operation of the starting switch 15 (S10).

The controller determines whether the fault diagnosis condition of the exhaust temperature sensor is satisfied if the starting of the vehicle is turned on.

The fault diagnosis condition may be satisfied if the driving time of the engine exceeds a predetermined driving time, the exhaust temperature exceeds a predetermined temperature and lasts during a predetermined time that the exhaust temperature exceeds the predetermined temperature.

Also, the fault diagnosis condition of the exhaust temperature sensor may be satisfied if the driving time of the engine exceeds the predetermined driving time and the exhaust temperature is less than a threshold temperature.

Next, the fault diagnosis condition and the fault diagnosis process of the exhaust temperature sensor will be described.

The controller determines whether the driving time T1 of the engine exceeds the predetermined driving time according to the starting of the vehicle (S20). In this case, the controller may calculate the driving time T1 of the engine from a time that an accumulation fuel injection amount reaches a predetermined value. For example, if the accumulation fuel injection amount exceeds 100 g, it is determined that the driving time T1 of the engine exceeds the predetermined driving time.

In the step of S20, if the driving time T1 of the engine exceeds the predetermined driving time, the controller determines whether the exhaust temperature exceeds the predetermined temperature and the time that the exhaust temperature exceeds the predetermined temperature lasts during the predetermined time (S40).

In the step of S40, that the exhaust temperature exceeds the predetermined temperature means that the driving of the engine 10 is normal. For example, if the exhaust temperature exceeds 130° C., it means that the engine 10 is the normal driving.

In the step of S20 and the step of S30, if the driving time T1 of the engine exceeds the predetermined driving time, the exhaust temperature exceeds the predetermined temperature, and the time that the exhaust temperature exceeds the predetermined temperature lasts during the predetermined time, the controller performs the control of the SCR catalyst 12.

In this case, the controller performs the fault diagnosis of the exhaust temperature sensor 13 (S50). That is, the controller may diagnose the fault of the exhaust temperature sensor 13 in the only state that the SCR catalyst 12 is activated.

When the fault of the exhaust temperature sensor is diagnosed, if the output voltage of the exhaust temperature sensor 13 exceeds the uppermost predetermined value (e.g., 4.8V), it may be diagnosed that the fault is generated in the power line of the exhaust temperature sensor 13, if the output voltage of the exhaust temperature sensor 13 is less than the lowermost predetermined value (e.g., 0.3V), it may be diagnosed that the fault is generated in the ground line of the exhaust temperature sensor 13.

Also, the controller continuously determines whether the engine 10 is driving every the predetermine time during the fault of the exhaust temperature sensor 13 is diagnosed (S60). In this case, the controller may determine whether the engine 10 is driving every second.

That is, if it is determined that the engine 10 is driving every the predetermined time, the step of S50 is returned and the fault of the exhaust temperature sensor is diagnosed while performing the SCR catalyst control (S50).

The diagnosis and determining condition of the exhaust temperature sensor may be variously set depending the situation of the hybrid vehicle.

In the step of S50, if the control of the SCR catalyst 12 is started, the reducing agent is injected to the exhaust gas in the injection module 14 such that the nitrogen oxide absorbed to the SCR catalyst 12 in the exhaust gas may be reduced. That is, the injection module 14 injects the reducing agent during the SCR catalyst 12 is controlled regardless of the fault of the exhaust temperature sensor 13 to reduce the nitrogen oxide absorbed to the SCR catalyst 12.

In the step of S60, if the engine 10 is not driving, the fault diagnosis of the exhaust temperature sensor 13 is finished (S70).

On the other hand, in the exhaust temperature sensor fault diagnosis method according to an exemplary embodiment of the present disclosure, after the step of S20, the step S30 that it is determined whether the exhaust temperature is larger than the threshold temperature may be further included.

Also, if the exhaust temperature is smaller than the threshold temperature, the controller diagnoses the fault of the exhaust temperature sensor 13 (S50). In this case, the threshold temperature may be set as the value smaller than the predetermined temperature.

That is, even if the driving time of the engine exceeds the predetermined driving time, that the exhaust temperature reaches the threshold temperature (e.g., 110° C.) may determine that the fault is generated in itself exhaust temperature sensor 13.

As described above, according to the exhaust temperature sensor diagnosis method of the hybrid vehicle according to an exemplary embodiment of the present disclosure, the fault of the exhaust temperature sensor is diagnosed only during the SCR catalyst is activated.

Also, as the fault of the exhaust temperature sensor is not diagnosed only during the SCR catalyst is inactivated, the erroneous sensing for the fault of the exhaust temperature sensor may be reduced.

While this present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

<Description of symbols>

| | |
|---|---|
| 10: engine | 11: exhaust pipe |
| 12: SCR catalyst | 13: exhaust temperature sensor |
| 14: injection module | 15: starting switch |
| 16: accelerator pedal sensor | 20: integrated starter-generator (ISG) |
| 30: engine clutch | 70: transmission |
| 80: drive shaft | 40: motor |
| 50: inverter | 60: battery |
| 110: ECU | 120: TCU |
| 130: HCU | 140: BMS |
| 150: PCU | 200: controller |

What is claimed is:

1. An exhaust temperature sensor fault diagnosis method of a hybrid vehicle comprising:
determining whether a starting of the vehicle is turned on depending on an operation of a starter switch;
determining whether a fault diagnosis condition of the exhaust temperature sensor is satisfied;
diagnosing the fault of the exhaust temperature sensor when the fault diagnosis condition of the exhaust temperature sensor is satisfied;
determining whether an engine is driving during the fault of the exhaust temperature sensor is diagnosed; and
finishing the fault diagnosis of the exhaust temperature sensor when the engine is not driving.

2. The exhaust temperature sensor fault diagnosis method of claim 1, wherein the fault diagnosis condition of the exhaust temperature sensor is satisfied when a driving time of the engine exceeds a predetermined driving time, an exhaust temperature exceeds a predetermined temperature, and the exhaust temperature lasts during a predetermined time that the exhaust temperature exceeds the predetermined temperature.

3. The exhaust temperature sensor fault diagnosis method of claim 2, wherein a fault in a power line of the exhaust temperature sensor is diagnosed when an output voltage of the exhaust temperature sensor exceeds an uppermost predetermined value, and
a fault in a ground line of the exhaust temperature sensor is diagnosed when the output voltage of the exhaust temperature sensor is smaller than a lowermost predetermined value.

4. The exhaust temperature sensor fault diagnosis method of claim 1, wherein the fault diagnosis condition of the exhaust temperature sensor is satisfied when a driving time of the engine exceeds a predetermined driving time and an exhaust temperature is smaller than a threshold temperature.

5. The exhaust temperature sensor fault diagnosis method of claim 4, wherein the fault of the exhaust temperature sensor is diagnosed when the driving time of the engine exceeds the predetermined driving time and the exhaust temperature is smaller than the threshold temperature.

6. The exhaust temperature sensor fault diagnosis method of claim 2 or claim 4, wherein when an accumulation fuel injection amount reaches a predetermined value, it is determined that the driving time of the engine exceeds the predetermined driving time.

7. An exhaust temperature sensor fault diagnosis system of a hybrid vehicle comprising:
an exhaust pipe in which an exhaust gas exhausted from engine flows;
a SCR catalyst installed at the exhaust pipe and configured to reduce a nitrogen oxide included in the exhaust gas;
an exhaust temperature sensor installed at a previous stage of the SCR catalyst and configured to measure an exhaust temperature; and
a controller configured to determine a fault of the exhaust temperature sensor when a fault diagnosis condition of the exhaust temperature sensor is satisfied.

8. The exhaust temperature sensor fault diagnosis system of claim 7, wherein the controller determines whether the fault diagnosis condition of the exhaust temperature sensor is satisfied when a driving time of an engine exceeds a predetermined driving time, the exhaust temperature exceeds a predetermined temperature, and the exhaust temperature lasts during a predetermined time that the exhaust temperature exceeds the predetermined temperature.

9. The exhaust temperature sensor fault diagnosis system of claim 8, wherein the controller diagnoses that a fault is generated in a power line of the exhaust temperature sensor when an output voltage of the exhaust temperature sensor exceeds an uppermost predetermined value, and diagnoses that an fault is generated in a ground line of the exhaust temperature sensor when the output voltage of the exhaust temperature sensor is smaller than a lowermost predetermined value.

10. The exhaust temperature sensor fault diagnosis system of claim 7, wherein the controller determines that the fault diagnosis condition of the exhaust temperature sensor is satisfied when a driving time of an engine exceeds a predetermined driving time and the exhaust temperature is smaller than a threshold temperature.

11. The exhaust temperature sensor fault diagnosis system of claim 10, wherein the controller diagnoses the fault of the exhaust temperature sensor when the driving time of the engine exceeds the predetermined driving time and the exhaust temperature is smaller than the threshold temperature.
